(19) United States
(12) Patent Application Publication
(10) Pub. No.: US 2020/0242251 A1
(43) Pub. Date: Jul. 30, 2020

(54) PROVIDING APPLICATION SECURITY, VALIDATION AND PROFILING TO AN APPLICATION

(71) Applicant: Citrix Systems, Inc., Fort Lauderdale, FL (US)

(72) Inventor: Jeffrey David Wisgo, Portland, OR (US)

(21) Appl. No.: 16/256,142

(22) Filed: Jan. 24, 2019

(51) Int. Cl. G06F 21/57; G06F 9/54

(52) U.S. Cl. CPC G06F 21/577; G06F 2221/033; G06F 9/54

(57) ABSTRACT

Systems and methods for application security are provided herein. A server can receive data from a variety of different sources to perform a security assessment of an application executing on a device. The server can identify security capabilities of first and second instances of the application based on properties of the first and second instances of the application and a plurality of application program interfaces (APIs) corresponding to the first and second instances of the application. The server can determine a difference in security capabilities of the first and second instances of the application. The difference in security capabilities indicating a security vulnerability of the first instance of the application. The server can provide application data to the application executable on the mobile device in response to the difference in security capabilities of the first and second instances of the application being at or above a threshold level.

### BACKGROUND

Operating systems can provide controls to various applications executing on a computing device regarding the ability to adapt or integrate the different functionalities of the applications. For example, the operating system can include policies that restrict or deny certain functionalities or limit the ability of one or more applications to interact with other applications executing on the computing device. Thus, complete integration between the various applications and systems on the computing device can be restricted or limited.

### SUMMARY

Systems and methods for providing application security through application identification, validation, and profiling to an application are provided herein. An application validator of an application server can receive or gather data from a variety of different sources to perform the security assessment of a mobile application available to a mobile device. The security assessment can identify security related capabilities and settings for the respective mobile application. The application validator can generate an application signature for an application and perform an identification of the application using the application signature. The application validator can compare the application signature to other accepted or known signatures to validate the respective application. The application validator can generate a permission profile for the respective application listing the security capabilities of the respective application. The permission profile can be provided to a mobile device, application server or administrator to identify the security capabilities of the application and monitor the security capabilities of the application during execution of the application.

In one aspect, this disclosure is directed to a method for application security. The method can include receiving, by a server, application data from a plurality of data sources. The application data can correspond to a first instance of an application executable on a mobile device. The method can include identifying, by the server, security capabilities of the first instance and a second instance of the application based on properties of the first and second instances of the application and a plurality of application program interfaces (APIs) corresponding to the first and second instances of the application. The method can include determining, by the server and responsive to the identification, a difference in security capabilities of the first and second instances of the application. The difference in security capabilities can indicate a security vulnerability of the first instance of the application. The method can include providing, by the server, application data from the plurality of data sources to the application executable on the mobile device in response to the difference in security capabilities of the first and second instances of the application being at or above a threshold level.

In some embodiments, the method can include identifying, by the server, static application data corresponding to the first instance of the application from a mobile application package or an administrator file. The method can include injecting, by the server, a monitoring module into the application and transmitting, by the monitoring module to the server, dynamic application data corresponding to the application during execution of the application. The method can include generating, by the server, a first application signature for the first instance of the application using the application data from the plurality of data sources, the application signature including properties of the first instance of the application and the plurality of APIs corresponding to the first instance of the application.

In some embodiments, the method can include comparing, by the server, the first application signature for the first instance of the application to a second application signature of the application during at least one of: at publishing time of the application or during execution of the application. The method can include validating, by the server, the first instance of the application by comparing the properties of the first and second instances of the application. The method can include assigning weight values to each of the properties of the first instance of the application and identifying the second instance of the application using a signature threshold and the assigned weight values for each of the properties of the first instance of the application.

In some embodiments, the method can include determining, by the server, one or more differences between the properties of the first instance of the application and the properties of the second instance of the application and generating, by the server, a validation report indicating the one or more differences between the properties of the first instance of the application and the properties of the second instance of the application. The method can include identifying, by the server, malicious logic included within the first instance of the application and preventing, by the server, the mobile device from accessing the first instance of the application. The method can include identifying, by the server, an updated version of the first instance of the application, the updated version having one or more different properties, updating, by the server, an application signature for the first instance of the application with the one or more different properties, and updating, by the server, a second application signature for the second instance of the application with the one or more different properties.

In some embodiments, the method can include identifying, by the server, an API of the plurality of APIs called by the application, the API different from APIs included in the properties of the first and second instances of the application and preventing, by the server, the application from executing the API. The method can include generating, by the server, a usage profile for the plurality of APIs corresponding to the application. The method can include compiling, by the server, a listing of security permissions requested by the plurality of APIs during execution of the application and generating, by the server, a security profile indicating responses to the security permissions requested by the plurality of APIs during execution of the application.

In another aspect, a system for application security is provided. The system can include a server. The server can be configured to receive application data from a plurality of data sources. The application data can correspond to a first instance of an application executable on a mobile device. The server can be configured to identify security capabilities of the first instance and a second instance of the application based on properties of the first and second instances of the application and a plurality of application program interfaces (APIs) corresponding to the first and second instances of the application. The server can be configured to determine, responsive to the identification, a difference in security capabilities of the first and second instances of the application. The difference in security capabilities can indicate a security vulnerability of the first instance of the application. The server can be configured to provide application data from the plurality of data sources to the application executable on the mobile device in response to the difference in security capabilities of the first and second instances of the application being at or above a threshold level.

In some embodiments, the server can be configured to inject a monitoring module into the application. The monitoring module can be configured to transmit, to the server, dynamic application data corresponding to the application during execution of the application. The server can be configured to validate the first instance of the application by comparing the properties of the first and second instances of the application.

In some embodiments, the server can be configured to generate a first application signature for the first instance of the application using the application data from the plurality of data sources. The application signature can include properties of the first instance of the application and the plurality of APIs corresponding to the first instance of the application. The server can be configured to compare the first application signature to a second application signature for the second instance of the application to determine the difference in security capabilities of the first and second instances of the application. The server can be configured to identify malicious logic included within the first instance of the application and prevent mobile device from accessing the first instance of the application.

In another aspect, a non-transitory computer-readable medium is provided that includes instructions that, when executed by the processor of a device, cause the processor to receive application data from a plurality of data sources. The application data can correspond to a first instance of an application executable on a mobile device. The instructions that, when executed by the processor of a device, cause the processor to identify security capabilities of the first instance and a second instance of the application based on properties of the first and second instances of the application and a plurality of application program interfaces (APIs) corresponding to the first and second instances of the application. The instructions that, when executed by the processor of a device, cause the processor to determine, responsive to the identification, a difference in security capabilities of the first and second instances of the application. The difference in security capabilities can indicate a security vulnerability of the first instance of the application. The instructions that, when executed by the processor of a device, cause the processor to provide application data from the plurality of data sources to the application executable on the mobile device in response to the difference in security capabilities of the first and second instances of the application being at or above a threshold level.

In some embodiments, the instructions that, when executed by the processor of a device, cause the processor to identify, responsive to the identification, an updated version of the first instance of the application. The updated version can include one or more different properties. The instructions that, when executed by the processor of a device, cause the processor to update the application signature of the first instance of the application with the one or more different properties. The instructions that, when executed by the processor of a device, cause the processor to update the at least one known signature corresponding to the second instance of the application with the one or more different properties.

The details of various embodiments of the invention are set forth in the accompanying drawings and the description below.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1 is a block diagram of embodiments of a computing device;

FIG. 2 is a block diagram of a system for providing application security, validation and profiling to an application; and

FIGS. 3A-3B are a flow diagram of a method for providing application security, validation and profiling to a mobile application.

### DETAILED DESCRIPTION

For purposes of reading the description of the various embodiments below, the following descriptions of the sections of the specification and their respective contents may be helpful:

Client device usage for performing sensitive or critical tasks is increasing as the client device can allow time critical functions to be performed anywhere and at any time. However, the freedom that a client device provides can increase the security risk that sensitive data corresponding to the critical tasks performed using the client device can be vulnerable to security attacks. For example, the critical tasks can correspond to a work task through a work environment that a client device is coupled with and in performing the task on the client device, sensitive data may end up stored or otherwise available through the client device. The work tasks can include applications accessed from different sources that can execute within the work environment through the client device and handle the sensitive data. An administrator for the work environment can have concerns about such sensitive data being improperly accessed, leaked, or modified via the client device. For example, the applications may include malicious logic or interact with typically restricted endpoints within the network. Thus, a need can arise to lock down or prevent the client devices or other systems coupled with the work environment from such security attacks that does not impact or limit the usability of the respective client devices or other systems.

The systems and methods described herein can provide application security through application identification, validation and profiling for a mobile application. An application validator executing on an application server or management server can gather application data from a variety of different sources, including static and run-time sources, to perform an analysis of an application (e.g., mobile application). The application validator can include logic or code injected in a mobile application by the server. The application validator can include an agent of the server having at least one processor to gather application data from a variety of different sources and to perform an analysis of the respective application. For example, the application validator can perform a security assessment of the application that includes application identification, validation, and profiling of security related capabilities and settings for the respective application. The capabilities and settings for the respective application, can include but are not limited to, power usage, file size, one or more application programming interfaces (APIs) accessed by the respective application, and permission dialogs requested by the respective application. The application validator can perform the security assessment of applications executing on client devices, such as but not limited to, computing devices, mobile devices or other forms of handheld devices.

Section A describes a computing environment which may be useful for practicing embodiments described herein; and

Section B describes embodiments of systems and methods for providing application security.

### A. Computing Environment

Prior to discussing the specifics of embodiments of the systems and methods detailed herein in Section B, it may be helpful to discuss the computing environments in which such embodiments may be deployed.

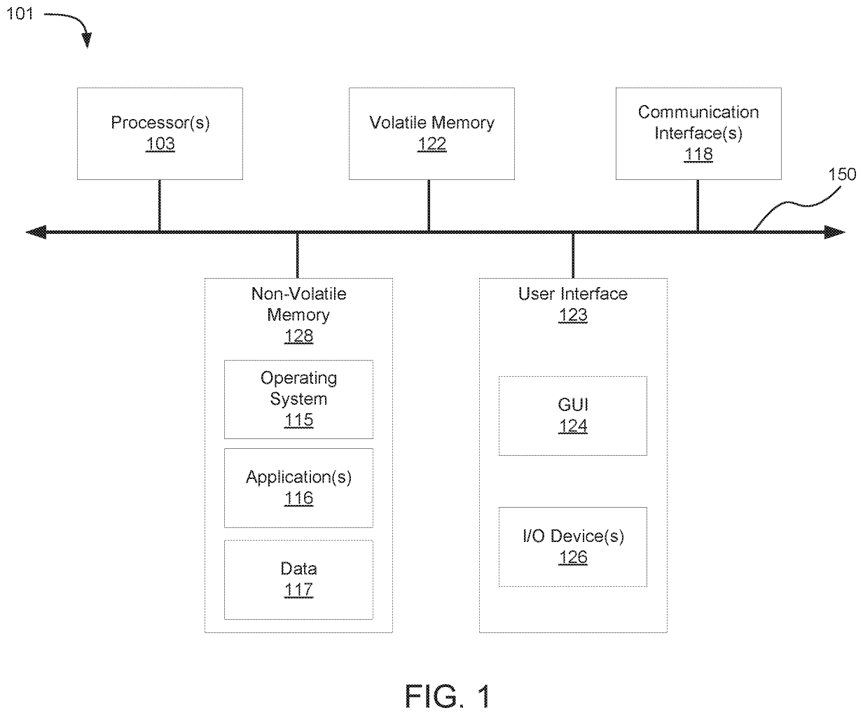

As shown in FIG. 1, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1 is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Additional details of the implementation and operation of network environment, computer 101 and client and server computers may be as described in U.S. Pat. No. 9,538,345, issued Jan. 3, 2017 to Citrix Systems, Inc. of Fort Lauderdale, Fla., the teachings of which are hereby incorporated herein by reference.

### B. Application Security

The systems and methods described herein can receive or gather data from a variety of different sources to perform the security assessment of one or more applications executing on a client device (e.g., mobile device). The security assessment can identify security related capabilities and settings for a respective application. The security related capabilities and settings for the respective application, can include but are not limited to, power usage, file size, one or more application programming interfaces (APIs) accessed by the respective application, and permission dialogs requested by the respective application. For example, an application validator executing on the client device can perform an identification of the application through an application signature. The application signature can correspond to a fingerprint for the application or group of data collected for the respective application to uniquely identify the application from other applications and describe what actions or functions the application performs. For example, the application signature can include an application name, an application identifier, file size data, API data (e.g., APIs associated with the application, APIs called by the application), security permission dialogs generated by the application, battery usage data, central processing unit (CPU) usage data and socket data (e.g., port data). The application validator can compare the application signature to other accepted or known signatures of other instances of the application to validate the respective application. For example, an instance of the application can include a different version of the same application or different formats of the same application. Thus, the application validator can compare the properties of different instances of the application to identify updates to the application, functionality issues for an application (e.g., using too much memory, calling wrong APIs), or malicious logic embedded within at least one instance of the application. The application validator can generate a permission profile for the respective application listing the security capabilities of the respective application. The permission profile can include a listing of actions or capabilities the application is permitted to perform or not permitted to perform, for example, when executing on a client device. The permission profile can include a listing of what APIs the application is permitted or not permitted to interact with. The permission profile can include what action the APIs associated with the application are permitted or not permitted to perform. The permission profile can include what security permission dialogs the application is permitted or not permitted to transmit. The permission profile can include what local files or devices of a client device the application is permitted or not permitted to interact with.

The application validator can detect unusual behavior of an application which can indicate a security issue with the respective application. The application validator can identify a tainted or modified version of the application which may have been modified to include malicious logic. In some embodiments, the application validator can determine that the application currently executing on the client device is an old version and therefore lacks a security update or updated functionality that the newer version of the application includes. The application validator can generate the permission profile for the application to include the security issues for an application and provide the permission profile to a user of the client device or an administrator of a network that includes the client device (e.g., virtual private network (VPN)). For example, the security issues can include, but not limited, a firewall update that is not included in the application, thus allowing the application to access an API that an administrator of the network has blocked. The security issues can include, but are not limited to, an API the application is repeatedly calling but is being blocked from accessing. The security issues can include, but are not limited to, a security permission dialog for access to a local device (e.g., request camera access) coupled with a client device that the respective application is not permitted to access. Therefore, the application validator can use the permission profile to block or deny certain functionalities of the application while executing on the client device. The application validator can use the permission profile to block or deny certain a client device from accessing different applications of the client device. The application validator can use the permission profile to block or deny applications from accessing or interacting with different application programming interfaces (APIs). Thus, the application validator can manage application security for one or more devices coupled with a network in a way that does not impact or limit the usability of the respective devices or other systems.

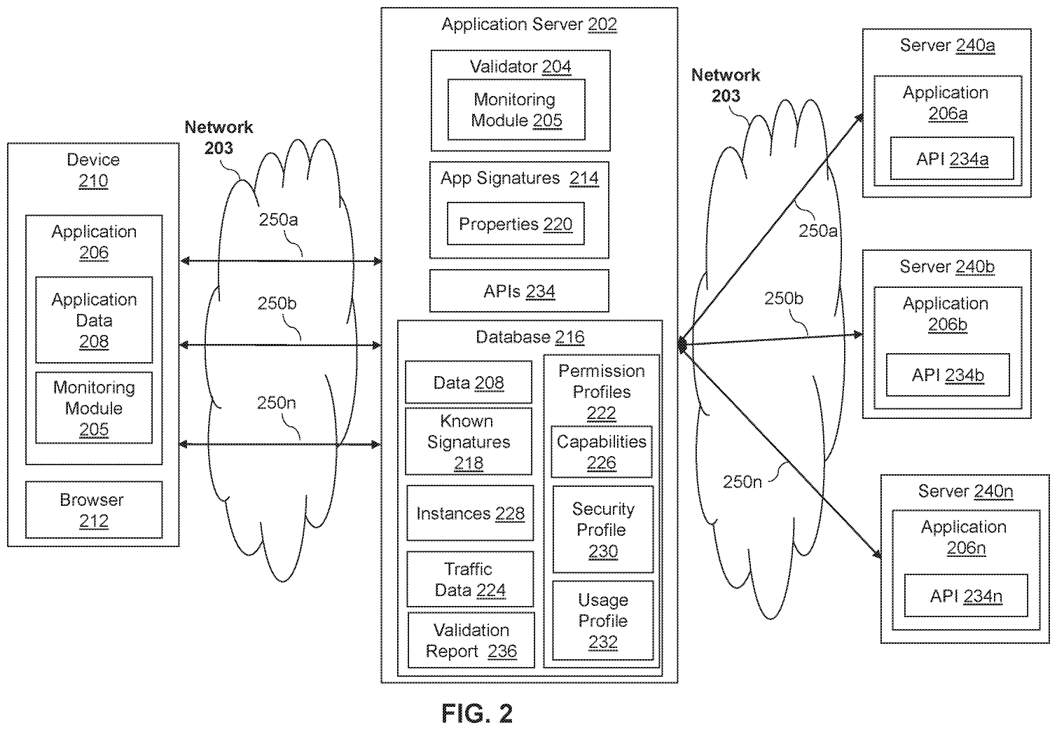

Referring to FIG. 2, depicted is a block diagram of one embodiment of an application server 202 having an application validator 204. The application server 202 can correspond to a management server for managing and controlling access to and execution of one or more applications 206 for one or more devices 210 coupled with the application server 202 through a network 203. The application server 202 can include an application validator 204 to provide application identification, and validation and profiling for a device 210 (e.g., mobile device, client device). For example, the application server 202 can couple with a plurality of servers 240a-240n to retrieve or receive a plurality of applications 206a-206n. The application validator 204 can perform an identification, a validation, and generate a permission profile for the applications 206a-206n to monitor different properties of the respective applications 206a-206n for the device 210, for the application server 202, and/or an administrator of the application server 202.

The application server 202 may correspond to or include a processor configured to manage properties of applications 206a-206n within the network 203. The application server 202 can include a network device or VPN device for managing network traffic within the network 203 between the device 210 and the plurality of servers 240a-240n. The application server 202 can monitor the access to, publishing of, downloading of, execution of, or other forms of interactions between an application 206 provided by at least one server 240 and the device 210. For example, the application server 202 can apply network policies to an application 206 to control (e.g., allow, block) the access to, publishing of, downloading of, execution of, or other forms of interactions involving the respective application 206. In some embodiments, the application server 202 may be transformed into a special-purpose microprocessor by executing computer-executable instructions or by otherwise being programmed.

The application validator 204 can include a processor to receive application data 208 corresponding to an application 206, generate an application signature 214 for the application 206, compare the application signature 214 to known signatures 218, validate the application 206 with respect to instances 228 of the application 206, determine security capabilities 226 of the application 206, and generate a permission profile 222 for the application 206. The application validator 204 can execute on the application server 202. In some embodiments, the application validator 204 can include a monitoring module 205 or monitoring agent 205. The monitoring module 205 can include a function, protocol or instructions for tracking and logging data corresponding to at least one application 206. The application validator 204 can transmit or provide the monitoring module 205 to a device 210 to track, monitor and log dynamic application data 208 corresponding to an application 206 executing on the device 210. The monitoring module 205 can transmit or provide the dynamic application data 208 to the application validator 204 or application server 202. In some embodiments, the application validator 204 may be transformed into a special-purpose microprocessor by executing computer-executable instructions or by otherwise being programmed.

The application server 202 can include a database 216. The database 216 can include or correspond to a database server. The database 216 can be a component of the application server 202 or subcomponents of the components within application server 202. In some embodiments, the database 216 can be an external database server coupled with the application server 202 through the network 203. Each of application server 202, application validator 204, and database 216 may be implemented or associated with hardware components, software components, or firmware components or any combination of such components. The application server 202, application validator 204, and database 216 can, for example, be implemented or associated with servers, software processes and engines, and/or various embedded systems.

The database 216 can include store, organize and maintain data generated, transmitted by or received by the application server 202 and the application validator 204. For example, the database 216 can include application data 208. The application data 208 can correspond to mobile application data 208. The application data 208 can include static application data and dynamic application data. The static application data can include data inputted by an administrator or application generator when the application 206 is compiled or published. The static application data can include meta data extracted from a mobile application package, for example, when the application 206 is being compiled or published. In some embodiments, the static application data can include an application name, minimum version of the application 206, maximum version of the application 206, APIs 234a-234n used by or corresponding to the application 206, file size data, and/or security capabilities of the application 206. The dynamic application data can include or correspond to application data 208 generated by an application 206 during execution (e.g., run time) of the application 206 on a device 210. The dynamic application data can include APIs 234a-234n called or requested by the application 206, security permission requests generated by the application 206, application running process data, disk space data, memory data, CPU usage, battery usage, and/or open socket data. The application data 208 can include network traffic data or VPN data corresponding to the application 206.

The application server 202 can include a plurality of application signatures 214 generated by the application validator 204. The application validator 204 can generate an application signature 214 for each application 206. The application signatures 214 can include properties 220 of the application 206 received by, generated by or extracted by the application validator 204. In some embodiments, the application signature 214 can include properties 220 such as, but not limited to, an application name, an application identifier (e.g., globally unique identifier (GUID)), application extension data, file size data, API data (e.g., APIs listed in binary files, APIs called during execution), security permission requests, security permission responses, battery usage data, and open socket data. The application signature 214 can correspond to a fingerprint or unique identifier for the application 206. In some embodiments, the application signature 214 can identify what actions or functions a respective application 206 performs. For example, the application signature 214 can include the APIs 234a-234n (e.g., GPS APIs) the application 206 calls to identify how the application 206 performs on a device 210 or what functions (e.g., navigation application) the application performs on a device 210. The application validator 204 can use the application signature 214 to identify application 206 from other applications 206 based in part on the different properties 220 of the respective application 206.

The database 216 can include a plurality of known signatures 218. The known signatures 218 can include or correspond to application signatures 214 that have been previously generated by the application validator 204 and approved or indicated as acceptable (e.g., meeting a security parameter) by the application validator 204. The known signatures 218 can include properties 220 of at least one application 206. The known signatures 218 can correspond to instances 228 of the application 206. Instances 228 of the application 206 can include different versions of the same application 206. The instances 228 can be generated to perform the same actions or same functions for a device 210. The instances 228 can be generated at different times or executed on different devices 210 resulting in one or more different properties 220 that can correspond to one or more differences between the signatures 214, 218 of the respective instances 228 even though the instances perform the same actions or same functions. For example, in some embodiments, the database 216 can include a first application signature 214 for a navigation application 206 and one or more known signatures 218 for one or more second instances 214 of the navigation application 206. Thus, each instance 228 can correspond to the navigation application 206, however the different instances 228 may have been generated at different times or include different versions of the same application 206. For example, the navigation application 206 may have been updated with new software or functionality (e.g., new firewall policies, new security permissions) from the previous instances 228 of the navigation application 206. In some embodiments, each known signature 218 can be linked with or grouped with at least one instance 228 of an application 206. The instances 228 of the application can include applications 206 that are of the same type and/or perform similar functions. In some embodiments, the known signatures 218 can be organized or grouped into subsets correspond to instances 228 of an application. For example, the known signatures 218 in flagged or grouped into the same instance 228 of an application can include a number of properties 220 or percentage of properties 220 that are the same and above a signature threshold indicating the known signatures 218 correspond to similar applications 206 or other instances of the same application 206. The signature threshold can include a numerical value corresponding to a number of properties 220 for applications 206 to be considered instances 228 of each other. In some embodiments, the signature threshold can include a percentage value corresponding to a percentage of properties 220 for applications 206 to be considered instances 228 of each other.

The database 216 can include network traffic data 224. The application validator 204 can use the network traffic data 224 to identify what end points (e.g., servers 240a-240n) an application 206 is attempting to access. The application validator 204 can use the network traffic data 224 to identify what APIs 234a-234n an application 206 is attempting to access. The network traffic data 224 can correspond to communications between the device 210 and the application server 202, communications between the device 210 and one or more servers 240 of the plurality of servers 240a-240n, and communications between the application server 202 and one or more servers 240 of the plurality of servers 240a-240n. The network traffic 224 can include requests from applications 206 executing on the device 210. For example, the network traffic 224 can include network calls for one or more APIs 234a-234n. The network traffic 224 can include responses from the application server 202 or the application validator 204 to the requests from the applications 206. The application validator 204 can use the network traffic 224 to determine if the application 206 is attempting to access blocked servers 240a-240n or APIs 234a-234n and thus attempting to violate one or more security policies of the network 203. The application validator 204 can use the network traffic 224 to determine if the application 206 is following one or more security policies of the network 203.

The database 216 can include a plurality of permission profiles 222 generated for a plurality of applications 206a-206n. In some embodiments, the application validator 204 can generate a permission profile 222 for each application 206 of the plurality of applications 206a-206n. The permission profile 222 can provide an administrator of the application server 202 or a user of the device 210 a listing of what actions the application 206 is performing, whether the actions have been allowed or blocked, a listing of APIs 234a234n that have been allowed or blocked, and a number of file accesses by the application 206. The application validator 204 can use the permission profile 222 to monitor the activity of an application 206 executing within the network 203, for example, on a device 210 coupled with the network 203. The application validator 204 can use the permission profile 222 to notify an administrator of the application server 202 or a user of a device 210 of the activity of an application 206. The permission profile 222 can include a listing of security capabilities 226 of the application 206, a security profile 230 for the application 206, and a usage profile 232 for the application 206. In some embodiments, the permission profile 222 can include policies from an administrator, from the application validator 204 or the application server 202 corresponding to the application 206, the usage profile 232, and/or the security profile 230. For example, the policies from the administrator can correspond to network policies or VPN policies for executing the application 206 on devices 210 coupled with or executing within the network 203. The security profile 230 can include security permission requests from one or more APIs 234a-234n. The security profile 230 can include responses from the application validator 204, the application server 202 or the device 210 to security permission requests from the one or more APIs 234a-234n. The usage profile 232 can include API data corresponding to APIs 234a-243n accessed by, used by or otherwise interacted with by the application 206. In some embodiments, the permission profile 222 can include data, such as, a number of file accesses by the application 206, a number of data bytes transmitted by the application 206, a number of data bytes received by the application 206. The permission profile 222 can include a plurality of different information corresponding to the interaction of an application 206 when executing on a device 210 or within a network 203. The database 216 can include a plurality of validation reports 236. The validation reports can include differences identified between properties 220 of an application 206 and the properties 220 of the other instances 228 of the application 206. The application validator 204 can use the validation reports 236 to validate and determine differences between a first instance 228 of an application 206 and one or more other instances 228 of the application 206. For example, the application validator 204 can use the differences between the instances 228 of the application 206 to identify security vulnerabilities or issues with the application 206. The security vulnerabilities or issues can include, but are not limited to, identifying an outdated version of the application 206, identifying a performance issue (e.g., using too much memory) with the application 206, and identifying malicious logic included within the application 206.

In some embodiments, the application server 202 can include a plurality of APIs 234a-234n. In some embodiments, the application server 202 can receive the plurality of APIs 234a-234n from the plurality of servers 240a-240n. The APIs 234a-234n can include APIs 234 called by, accessed by or interacted with by one or more applications 206a-206n provided by the plurality of servers 240a-240n. The application server 202 can track and log the APIs 234a-234n called by, accessed by or interacted with by one or more applications 206a-206n executing on device 210 or executing with network 203.

The device 210 can be a client device, such as but not limited to a mobile device. The device 210 can couple with the application server 202 and the plurality of servers 240a-240n through network 203. The device 210 can include or correspond to an instance of any client device, mobile device or computer device described herein. For example, the device 210 can be the same as or substantially similar to computer 101 of FIG. 1. The device 210 can include a browser 212 for accessing, downloading or interacting with an application 260. For example, the device 210 with the browser 212 (e.g., embedded browser (CEB)) can include a CEB. The browser 212 can include elements and functionalities of a web browser application or engine. The browser 212 can locally render one or more of application 206a-206n as a component or extension of systems of the device 210. For example, the browser 212 can render a SaaS/Web application inside the CEB which can provide the CEB with full visibility and control of at least one application session executing on device 210. The device 210 can couple with the application server 202 and the plurality of servers 240a-240n to download at least one application 206. The device 210 can execute or run the application 206 based in part on a permission profile 222 generated for the application 206. The application 206 executing on the device 210 can include application data 208, such as static application data and dynamic application data. In some embodiments, the application validator 204 can provide or transmit a monitoring module 205 (or monitoring agent) with the application 206 to track and log dynamic application data. The application validator 204 can receive the dynamic application data from the monitoring module 205 to update an application signature 214 of the application 206 and/or a permission profile 222 of the application 206. In some embodiments, the application validator 204 can provide or display the permission profile 222 for an application 206 with the browser 212 of the device 210 when the device 210 downloads the application 206, activates or opens the application 206 or executes the application 206. Thus, in some embodiments, the application validator 204 can provide real time data corresponding to the application 206 to a user of the device 210 as the application 206 executes on the device 210.

In some embodiments, the application validator 204 can establish one or more sessions 250a-250n to one or more of applications 206a-206n (e.g., network applications). For example, the application validator 204 can establish one or more sessions 250a-250n to one or more of applications 206a-206n through the browser 212 and network 203 for the device 210. The application validator 204 can establish a single session 250 between the device 210 and at least one server 240. The application validator 204 can establish multiple sessions 250a-250n between the device 210 and the servers 240a-240n. In some embodiments, the application validator 204 can establish multiple sessions 250a-250n at the same time between the device 210 and the servers 240a-240n such that the multiple sessions 250a-250n are executing simultaneously to provide the device 210 access to multiple applications 206a-206n hosted by the respective servers 240a-240n. The sessions 250a-250n may include, but not limited to, an application session, an execution session, a desktop session, a hosted desktop session, a terminal services session, a browser session, a remote desktop session, a URL session and a remote application session. Sessions 250a-250n may include encrypted and/or secure sessions established between an application 206 and the device 210. For example, the sessions 250a-250n may include encrypted URL sessions and/or secure URL sessions established between at least one application 206 and the device 210 through the network 203 (e.g., VPN network 203). The encrypted URL sessions 250a-250n can include encrypted data or traffic transmitted between at least one application 206 and the device 210 through the network 203.

The applications 206a-206n may include applications (apps) that are served from and/or hosted on one or more servers, here servers 240a-240n (e.g., third party servers). The applications 206a-206n can include an application 206 hosted on at least one server 240 accessed by the device 210 via the network 203. The applications 206a-206n may include applications (apps) that are served from and/or hosted on one or more servers 240a-240n, such as but not limited to, web applications, software-as-a-service (SaaS) applications, and/or remote-hosted applications. The applications 206a-206n can include, but not limited to, a web application, a desktop application, remote-hosted application, a virtual application, a software as a service (SaaS) application, a mobile application, an HDX application, a local application, and/or a native application (e.g., native to the device 210). The applications 206a-206n can include one or more APIs 234a-234n. The APIs 234a-234n can include a function, protocol or set of instructions for controlling interactions between an application 206 and the device 210, the application server 202, and/or the application validator 204. In some embodiments, the APIs 234a-234n can control access to hardware devices and software functions that an application 206 may not necessarily have permission to use or functionality to access. The APIs 234a-234n can include or correspond to an API of an operating system executing on the device 210. For example, the APIs 234a-234n can correspond to an API for providing or invoking a web view within the browser 212 (or native application) executing on the device 210 to control and provide web content corresponding to an application 206.

Network 203 may be a public network, such as a wide area network (WAN) or the Internet. In some embodiments, network 203 may be a private network such as a local area network (LAN) or a company Intranet. Network 203 may be a public network, such as a wide area network (WAN) or the Internet. Network 203 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, device 210 and one or more of servers 240a-240n may be on the same network 203. In some embodiments, device 210 and one or more of servers 240a-240n may be different networks 203. The network 203 can include a virtual private network (VPN). The VPN can include one or more encrypted sessions 250a-250n from the device 210 to the application server 202 or the plurality of servers 240a-240n over network 203 (e.g., internet, corporate network, private network).

Each of the above-mentioned elements or entities is implemented in hardware, or a combination of hardware and software, in one or more embodiments. Each component of the application validator 204 may be implemented using hardware or a combination of hardware or software detailed above in connection with FIG. 1. For instance, each of these elements or entities can include any application, program, library, script, task, service, process or any type and form of executable instructions executing on hardware of a client device (e.g., the device 210). The hardware includes circuitry such as one or more processors in one or more embodiments. In some embodiments, the application validator 204 can be deployed on the application server 202. In some embodiments, the application validator 204 can be deployed on the device 210. For example, the application validator 204 can correspond to logic or code injected in an application 206 provided to the device 210 and executing on the device 210. The application validator 204 can include an agent of the application server 202 injected in an application 206 provided to the device 210 and executing on the device 210. In some embodiments, the application server 202 can inject the application validator 204 in an application 204 through wrapping tools when the respective application 206 is compiled or published. The application validator 204 can correspond to a management layer applied to the code of the application 206 to monitor the behavior and actions of the respective application 206. Thus, the application validator 204 can gather application data corresponding to the application 206 when the application 206 is executing on the device 210.

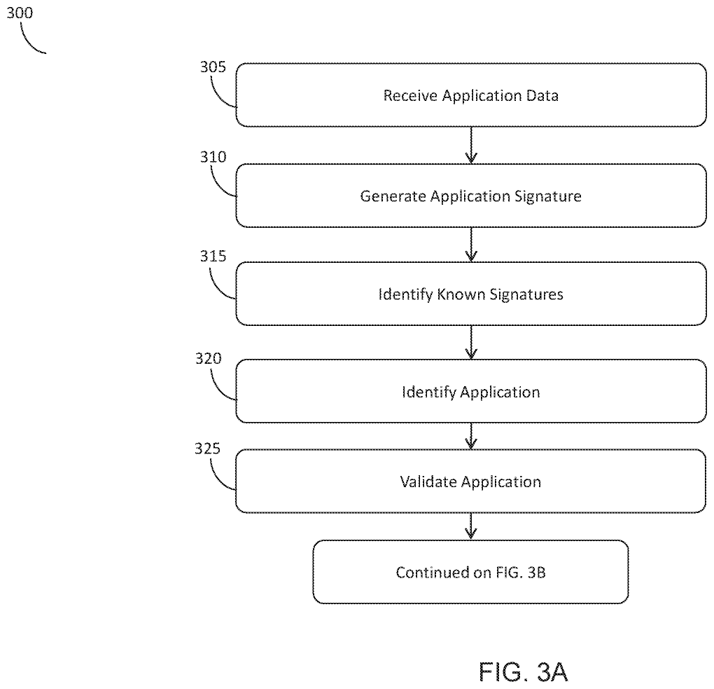

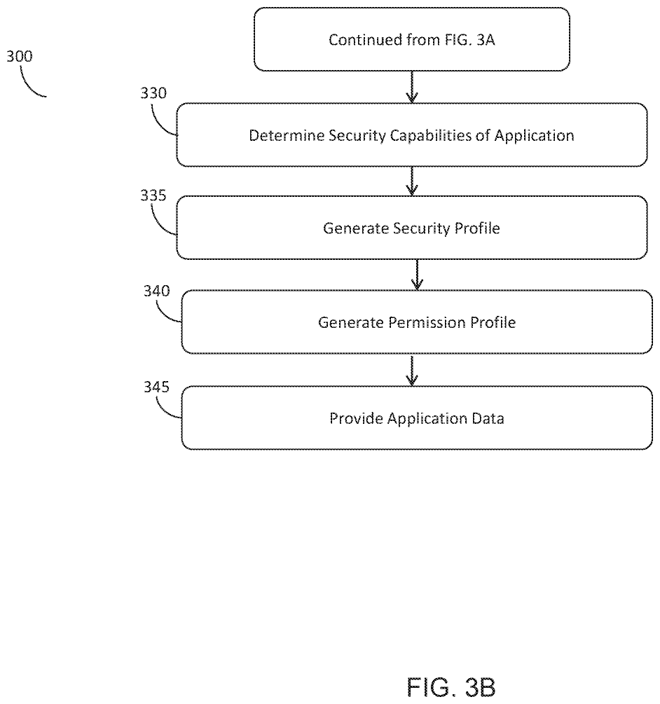

Referring now to FIGS. 3A-3B, depicted is a flow diagram of one embodiment of a method 300 for providing application security though application identification, validation and profiling for an application executing on a device, such as a mobile device. The functionalities of the method 300 may be implemented using, or performed by, the components detailed herein in connection with FIGS. 1-2. In brief overview, static application data and dynamic application data can be received (305). An application signature can be generated (310). Known signatures can be identified (315). Application identification can be performed (320). Application validation can be performed (325). Security capabilities can be determined (330). A security profile can be generated (335). A permission profile can be generated (340). The application data can be provided (345).

Referring now to operation (305), and in some embodiments, data can be received corresponding to one or more applications 206. For example, the method 300 can include receiving, by a server 202, application data 208 from a plurality of data sources. The application data 208 can correspond to a first instance of an application 206 executable on a mobile device 210. In some embodiments, the method can include receiving, by an application validator 204 executing on an application server 202, application data 208 from a plurality of data sources. The application data 208 can correspond to at least one application 206 (e.g., mobile application) executing on a device 210 (e.g., client device, mobile device). In embodiments, the application validator 204 can extract or receive application data 208 from a variety of different sources to appropriately profile an application 206. The applications 206 can include, but not limited to, mobile applications 206 executing on the device 210.

The application validator 204 can extract or receive application data 208 including, but not limited to, static data (e.g., static meta data), dynamic data, and network traffic data. For example, the application validator 204 can extract or receive static application data 208 from that manually inputted by an administrator when the corresponding application 206 is published or provided to an application marketplace, or otherwise made available for download or execution by a device 210. The application data 208 can include an application name, a minimum version of the application 206, a maximum version of the application 206, security policies corresponding to the application 206, and platforms supported by the application 206.

The application validator 204 can extract or receive static application data 208 extracted from an application package (e.g., mobile application) when the application 206 is compiled, before the corresponding application 206 is published or during the publish time of the corresponding application 206. For example, the application validator 204 can access a database 216 of the application server 202 to retrieve application data 208 corresponding to an application 206. The application validator 204 can identify an application package corresponding to an application 206 to be compiled or published. For example, the application package can include logic, code and application data 208 for generating the respective application 206. The application validator 204 can access the application package to retrieve the application data 208 for the respective application 208. In some embodiments, the application validator 204 can extract static application data 208 from the application package that includes at least one of or any combination of: a listing of APIs 234a-234n associated with the application 206, a file size, security protocols (e.g., security entitlements), extension data (e.g., bundled extensions), application version data, or application identifiers (e.g., globally unique identifier (GUID)).

In some embodiments, dynamic application data 208 can be received corresponding to one or more applications 206a-206n. In some embodiments, the application validator 204 can receive dynamic application data 208 during execution of the application 206 on the device 210. For example, the application validator 204 can transmit or provide a monitoring module 205 to the device 210. The monitoring module 205 can include or correspond to code or logic provided to or injected into the application 206 to track or log dynamic application data 208 corresponding to the application 206 or network traffic data 224 corresponding to the application 206. For example, the application validator 204 can inject or provide the monitoring module 205, having code or logic, through wrapping tools or through a custom software developers kit (SDK) when the application 206 is being compiled or published. The network traffic data 224 can include an external view of network traffic corresponding to an application 206, for example, from a VPN or on a per-application basis.

The application validator 204 can extract or receive dynamic application data 208 corresponding to one or more APIs called during execution or run time of the corresponding application 206. The dynamic application data 208 can include data corresponding to how the device 210 interacts with, executes or responds to one or more APIs 234a-234n. For example, in some embodiments, the dynamic application data 208 can include security permission requests or data for an interaction between an API 234 and the application 206 executing on the device 210. The security permission requests can include a dialogue exchange between an API 234 and the application 206 executing on the device 210. In some embodiments, the security permission requests may include, but not limited to, “use camera?” dialog was displayed, “use address book?” dialog was displayed, “use location?” dialog was displayed. The dynamic application data 208 can include security permission responses from the device 210, the application server 202 or application validator 204 to the security permission requests. For example, the security permission responses can include a response indicating if the corresponding security permission request was granted (e.g., allowed), partially granted, denied, or partially denied. The dynamic application data 208 can include operating system APIs 234a-234n external to or different from the device 210. In some embodiments, the dynamic application data 208 can include network APIs (e.g., open socket), file APIs (e.g., write file), audio APIs (e.g., play a sound), Bluetooth APIs, address book APIs, GPS/location APIs, background execution APIs, and/or VPN APIs.

The application validator 204 can extract or receive dynamic application data 208 corresponding to an application execution data. For example, the application validator 204 can probe or extract dynamic application data 208 corresponding to an application running process or sandbox runtime when executing on a device 210. The application validator 204 can probe or extract dynamic application data 208 when the application 206 is executing on a device 210 or at least one of servers 240. For example, the application validator 204 can monitor the application 206 when the application 206 is executing on the device 210. The application validator 204 can track and log the actions (e.g., APIs 234a-234n called) by the application 206 when executing on the device 210. The application validator 204 can monitor the application 206 when the application 206 is accessed by the device 210 and executing on a sever 240. The application validator 204 can track and log the actions (e.g., permission dialogs requested) by the application 206 when accessed by the device 210 through the server 240. The application execution data can include remaining disk space, remaining memory, central processing unit (CPU) usage, battery usage, and/or a number of open sockets. In some embodiments, the application validator 204 can extract or receive application data 208 corresponding to network traffic. For example, the application validator 204 can extract or receive the network traffic data corresponding to an application 206 by tracking or logging network traffic or data received at the application 206 or transmitted from the application 206 through the monitoring module 205. In some embodiments, the application validator 204 can extract or receive the network traffic data corresponding to an application 206 by tracking or logging network traffic or data received at an API 234 called by the application 206 or transmitted by an API 234 called by the application 206. In some embodiments, the application validator 204 can receive or extract only static application data 208. In some embodiments, the application validator 204 can receive or extract only dynamic application data 208. In some embodiments, the application validator 204 can receive or extract a combination of the static application 208 and dynamic application data 208. The application validator 204 can attempt to access different types of application data 208 (e.g., static, dynamic) from a plurality of different sources to appropriately profile an application 206.

Referring now to operation (310), and in some embodiments, an application signature 214 can be generated for an application 206 to uniquely identify the application 206 from other applications 206 and describe what actions or functions the respective application 206 performs. For example, the method 300 can include generating, by the application validator 204, an application signature 214 for the application 206 using the application data 208 from the plurality of data sources. The application signature 214 can correspond to a collection of application data 208 compiled for an application 206 that uniquely identifies the respective application 206 from other applications 206 and other instances of the application 206. For example, the application signature 214 can include application data 208, such as but not limited to, an application name, an application identifier, file size data, API data (e.g., APIs associated with the application, APIs called by the application), security permission dialogs generated by the application, battery usage data, central processing unit (CPU) usage data and socket data (e.g., port data). The application validator 204 can use the application signature 214 to identify updates to an application 206, functionality issues for an application 206 (e.g., using too much memory, calling wrong APIs), or malicious logic embedded within an application 206. The application signature 214 can include properties 220 of the application 206 and a plurality of application program interfaces (APIs) 234a-234n corresponding to the application 206. The application validator 204 can generate the application signature 214 having any combination of application data 208. The application validator 204 can compile the application data 208 received corresponding to the application 206 to generate an application signature 214 that describes what the application 206 is and the actions the application 206 performs. For example, the application signature can correspond to a fingerprint for the respective application 206. Thus, each of the applications 206a-206n can have unique application signatures 214.

The application validator 204 can generate an application signature 214 for different applications 206 using the same types of data and/or the same application properties (e.g., file size, battery usage, APIs). In some embodiments, the application validator 204 can generate an application signature 214 for different applications 206 using different types or combinations of data and/or different combinations of application properties (e.g., file size, battery usage, APIs). For example, the application validator 204 can generate an application signature 214 for a first application 206 using different types of data or different application properties (e.g., file size, battery usage, APIs) as compared to an application signature 214 generated for a second application 206, different from the first application 206. In some embodiments, the application signature 214 can include an application name, an application identifier (e.g., GUID), extension data, file size, API data, security permission dialogue data, battery data, and/or open socket data. The API data can include APIs listed in binary (e.g., network APIs, security APIs, file APIs, address book APIs, camera APIs) and APIs used during execution of the application 206 (e.g., run time APIs including but not limited to, network APIs, security APIs, file APIs, address book APIs). The security permission dialogue data can include dialogue or exchanges between an API 234 and the application 206 when the application 206 is executing (e.g., run time). In some embodiments, the security permission dialogue data can include, but not limited to, use address book exchanges or use camera access requests.

Referring now to operation (315), and in some embodiments, known signatures 218 can be identified to provide a comparison point for identifying the application 206. For example, the application validator 204 can identify known signatures 218 corresponding to different instances 228 of the application 206. The application validator 204 can use the known signatures 218 to perform identification of an application 206 based in part on a degree of differences between the applications signature 214 of the application 206 and one or more known signatures 218 of one or more instances 228 of the application 206. In some embodiments, the application validator 204 can identify a plurality of known signatures 218 (e.g., known application signatures) corresponding to applications 206 that have been previously compiled, published or executed. The known signatures 218 can include application signatures 214 that have been approved by the application validator 204 as meeting a security threshold. For example, the application validator 204 can flag an application signature 214 as being a known signature 218 responsive to identifying and validating the application signature 214 using the methods of method 300 of FIGS. 3A-3B.

The plurality of known signatures can be stored in a database 216 executing on the application server 202. The plurality of known signatures 218 can be stored in a database 216 of an external server, external to the application server 202 and communicatively coupled with the application server 202. In some embodiments, the application validator 204 can receive known signatures 218 from one or more of the servers 240a-240n. The known signatures 218 from the servers 240a-240n can correspond to application signatures 214 of applications 206a-206n the servers 240a-240n host or provide. In some embodiments, the application validator 204 can group the plurality of known signatures 218 into different instances 228 of applications 206. For example, the application validator 204 can group signatures 218 from similar applications 206 (e.g., same name, same function) or the same type of applications 206 into a single or common instance 228 of applications 206 (e.g., instance of applications). The known signatures 218 can be grouped based in part on a type of the application, function of the application or APIs 234a-234n corresponding to the application 206. For example, known signatures 218 for security related applications 206 can be grouped in or flagged as the same instance of an application 206. In some embodiments, known signatures 218 for GPS related applications 206 can be grouped in or flagged as the same instance of an application 206. Known signatures 218 for mail related applications 206 can be grouped in or flagged as the same instance of an application 206. In some embodiments, applications 206 using the same or similar APIs 234a-234n can be grouped in or flagged as the same instance of an application 206.

Referring now to operation (320), and in some embodiments, the application 206 can be identified to determine or confirm which application 206 the application validator 204 is interacting with or monitoring. For example, the method 300 can include identifying, by the server 202, security capabilities 226 of the first instance and a second instance of the application 206 based on properties 220 of the first and second instances of the application 206 and a plurality of APIs 234a-234n corresponding to the first and second instances of the application 206. In some embodiments, the application validator 204 of the application server 202 can perform identification of an application 206 to confirm that the application 206 is a correct version based on differences between the application signature 214 and one or more known signatures 218. For example, the application validator 204 can use the identification to verify a version of the application 206, check for mistakes during publishing of the application 206 or determine if the application 206 is a malicious application 206. The identification of the application 206 can be performed using properties 220 of the application 206. For example, method 300 can include comparing, by the application validator 204, the application signature 214 to a plurality of known signatures 218 to identify at least one known signature 218 having a number of properties 220 that match a signature threshold for the properties 220 of the application 206. The at least one known signature 218 can correspond to an instance 228 of the application 206.

As indicated above, the comparison can be referred to as identifying the application 206. For example, the application validator 204 can compare the application signature 214 generated for the application 206 to different known signatures 218 to identify the application 206 or determine what the application 206 is. The application signature 214 can have a number of properties 220 in common with at least one known signature 218 of the plurality of signatures 218 indicating the application 206 is the same application 206, same type of application 206, belongs in the same category of applications, and/or is a different instance 228 of the application corresponding to the at least one known signature 218. The properties 220 can include, but not limited to, an application name, an application identifier (e.g., GUID), extension data, file size, API data, security permission dialogue data, battery data, and/or open socket data. The signature threshold can include a numerical value. For example, if the application signature 214 and a known signature 218 have greater than three properties in common, the application validator 204 can group or flag the application 206 as another instance 228 of the applications 206 corresponding to the respective known signature 218. The numerical value for the signature threshold can vary and be selected based at least in part on a number of properties 220 included in the application signature 214 or known signature 218. In some embodiments, the signature threshold can include a percentage value. For example, if the application signature 214 and a known signature 218 have greater than 75% properties in common, the application validator 204 can group or flag the application 206 as another instance 228 of the applications 206 corresponding to the respective known signature 218. The percentage value for the signature threshold can vary and be selected based at least in part on a number of properties 220 included in the application signature 214 or known signature 218.

The application validator 204 can perform the comparison or deification at different times or periods during a lifetime of the application 206. For example, the application validator 204 can perform the comparison or identification when the application 206 is being compiled or during a wrapping time of the application 206. The application validator 204 can use an application signature generated during compilation of the application 206 and compare it to one or more known signatures 218. The application validator 204 can compare the application signature 214 of the application 206 to one or more known signatures 218 as the respective application 206 is being compiled. The application validator 204 can compare the application signature 214 of the application 206 to one or more known signatures 218 after the respective application 206 has been compiled. In some embodiments, the application validator 204 can perform the comparison or identification when the application 206 is being published, uploaded or otherwise made available (e.g., available for download) for one or more devices 210. The application validator 204 can perform the comparison or identification when the application 206 executing (e.g., run time) on the device 210. The application validator 204 can use an application signature generated after the application 206 has been published or after the application has been downloaded by a device 210. The application validator 204 can compare the application signature 214 of the application 206 to one or more known signatures 218 as the respective application 206 is being uploaded or otherwise made available to one or more devices 210. The application validator 204 can compare the application signature 214 of the application 206 to one or more known signatures 218 when the respective application 206 is executing on the device 210.

In some embodiments, the instances 228 can indicate different versions of the application 206. For example, the differences between the application signature 214 and the known signatures 218 can indicate different versions of the application 206. The application validator 204, responsive to the comparison, can flag or move the application 206 into a category of applications 206 corresponding to the known signatures 218. The category of applications 206 can include multiple instances 228 of the application 206. For example, there can be different versions of an application 206 compiled or published. Thus, the application validator 204 can group or organize the different instances 228 of the application 206 together to provide a more streamlined way to manage, report and apply security policies to the different instances 228 of similar or common applications 206. In some embodiments, the application validator 204 can apply a security policy to the group or category of applications 206 instead of applying the security policy to each application 206 individually. The application validator 204 can manage the group or category of applications 206 instead of managing each application 206 individually. The application validator 204 can generate reports for the group or category of applications 206 instead of generating reports for each application 206 individually.

In some embodiments, the application validator 204 can compare the application signature 214 generated for the application 206 to different known signatures 218 to identify differences between the application signature 214 and the known signatures 218. For example, the differences can correspond to mistakes or errors in compiling or publishing the application 206. In some embodiments, the mistakes can correspond to properties of the application 206 being incorrect, such as but not limited to, an incorrect application name, file size or incorrect APIs listed. In some embodiments, the differences between the application signature 214 and the known signatures 218 can indicate malicious logic included or embedded within the application 206. The differences between the application signature 214 and the known signatures 218 can indicate that the application 206 is a fake application or rogue application. For example, the fake application or rogue application can have one or more similar properties (e.g., same name, similar APIs) as the applications 206a-206b corresponding to the known signatures 218, however, the fake application or rogue application can correspond to a virus or malicious software program intended to harm the device 210 when executing on the device 210.

The application validator 204 can use different algorithms to compare or identify the application 206. For example, the application validator 204 can execute an identification algorithm that to compare properties 220 of the application signature 214 to the properties 220 of the known signatures 218. The comparison of the properties 220 can identify differences between an application signature 214 of an application 206 and one or more known signature 218 of one or more instances 228 of the application 206 that may correspond to malicious code embedded within the application 206 or malicious actions attempted by the application 206. For example, in some embodiments, the differences in properties 220 can include a difference in security permission dialogues generated by the application 206 while executing on the device 210 as compared with security permission dialogues generated by the one or more instances 228 of the application 206. The difference in security permission dialogues can correspond to malicious code embedded within the application 206 that causes the application 206 to retrieve sensitive or secure data (e.g., passwords, financial accounts) the application 206 is not permitted to access. Thus, the application validator 204 can execute the identification algorithm to identify if the application 206 is operating differently from other instances 228 of the same application 206 to identify malicious actions. The identification algorithm can include a set of instructions causing the application validator 204 to retrieve properties 220 from the application signature 214 of the application 206 and retrieve to the properties 220 of the known signatures 218 from one or more categories of applications 206. The identification algorithm can include a set of instructions causing the application validator 204 to compare the properties 220 of the application signature 214 to the properties 220 of the known signatures 218. The identification algorithm can include a set of instructions causing the application validator 204 to identify common properties 220 between the properties 220 of the application signature 214 and the properties 220 of the known signatures 218. The identification algorithm can include a set of instructions causing the application validator 204 to identify differences between the properties 220 of the application signature 214 and the properties 220 of the known signatures 218.

In some embodiments, the application validator 204 can assign weight values to each of the properties 220. In some embodiments, the application validator 204 can assign weight values to each of the properties 220 of the application 206 and identify the category of applications 206 corresponding to the application 206 using the signature threshold and the assigned weight values for each of the properties 220 of the application 206. For example, the application validator 204 can assign weight values indicating a rank or importance of the respective property 220. In some embodiments, a first property 220 can be assigned a first weight value, a second property 220 can be assigned a second weight value, a third property 220 can be assigned a third weight value, and a fourth property 220 can be assigned a fourth weight value. The first weight value can be greater than or higher than the second, third and fourth weight values. The second weight value can be greater than or higher than the third and fourth weight values. The third weight value can be greater than or higher than the fourth weight value. The number of weight values can vary and be selected based at least in part on the number of properties 220 of an application signature 214 or known signature 218.

Referring now to operation (325), and in some embodiments, the application 206 can be validated. For example, the method 300 can include determining, by the server 202 and responsive to the identification, a difference in security capabilities 226 of the first and second instances of the application 206. The difference in security capabilities can include a security vulnerability (e.g., malicious logic, out of date version) of the first instance of the application 206. In some embodiments, the method 300 can include validating, by the application validator 204, the application 206 by comparing properties 220 of the instances 228 of the application 206 to the properties 220 of the application 206. The validation can include comparing properties 220 of the applications 206 to properties 220 of applications 206 identified as different instances 228 of the application 206 and indicated as being the same type or similar to the application 206. For example, responsive to the comparison or identification of the application 206, differences can be identified between the application 206 and instances 228 of the application 206. The instances 228 of the application 206 can include applications that are the same type of application 206, different versions of the application 206 or similar applications 206 (e.g., perform a similar function) to the application 206 executing on the device 210. The application validator 204 can perform the validation to identify the differences between the application 206 and instances 228 of the application 206. In some embodiments, the application validator 204 can use a most recent or group of most recent instances 228 of the application 206. For example, the application validator 204 can select an instance 228 or group of instances 228 based in part on a time stamp associated with the instances 228 of the application 206 when the instances 228 of the application 206 are saved to the database 216. The application server 202 can save the instances 228 of the application 206 for various time periods (e.g., one month, one year). The application server 202 can save the instances 228 of the application 206 until a new or updated instance 228 of the application 206 is saved in the database 216.

In some embodiments, the validation can include comparing performance metrics of instances 228 of the application 206 to performance metrics of the application 206. For example, the performance metrics can include API usage, memory usage, network usage, bandwidth usage, and/or processor usage. The application validator 204 can perform the validation to determine if the application 206 is using more or less memory than other instances 228 of the application 206. In some embodiments, the application validator 204 can perform the validation to determine if the application 206 is using one or more different APIs 234a-234n from the other instances 228 of the application 206. The application validator 204 can perform the validation to determine if the application 206 is using more or less network traffic or bandwidth as compared to other instances 228 of the application 206. In some embodiments, the application validator 204 can perform the validation to determine if the application 206 is using or accessing a public network or private network (e.g., VPN) not being accessed or used by other instances 228 of the application 206. The application validator 204 can perform the validation to determine if the application 206 is using more or less processing power to perform similar functions as compared to other instances 228 of the application 206. For example, in some embodiments, the differences in processing power can correspond to malicious logic embedded within an application 206. The malicious logic (e.g., bug, virus) can slow down one or more processors of the device 210 executing the application 206. The malicious logic can cause a memory leak for one or more memory units or databases of the device 210 executing the application 206. The malicious logic (e.g., bug, virus) can result in decreased (e.g., slower) performance by the device 210 executing the application 206. The application validator 204 can perform the validation to compare the performance of the application 206 to other instances 228 of the application 206 to determine if there are differences and if the differences are caused by malicious intent or due to security vulnerabilities. In some embodiments, the application validator 204 can perform the validation to identify the differences in the execution of the application 206 and determine if the differences are caused by malicious logic embedded within the application 206, caused by an out of date version of the application 206, or a new updated version of the application 206 executing new functionality that other instances 228 of the application 206 may not include.

In some embodiments, a validation report 236 can be generated. In some embodiments, the application validator 204 can determine one or more differences between the properties 220 of the application 206 and the properties 220 of the other instances 228 of the application 206. The application validator 204 can generate a validation report 236 indicating the one or more differences between the properties 220 of the application 206 and the properties 220 of the other instances 228 of the application 206. For example, responsive to the validation, the application validator 204 can generate a validation report 236 identifying the differences, if any, between the application 206 and the other instances 228 of the application 206. The application validator 204 use the differences to determine if any of the differences correspond to issues with the application 206 or issues with a device 210 executing the application 206. In some embodiments, the validation report 236 can identify if an administrator, the application server 202 or device 210 received a tainted version of the application 206 having malicious logic. The application validator 204 can identify, responsive to the validation, malicious logic included within the application 206. The application validator 204 can prevent or block the device 210 from accessing, downloading, or interacting with the application 206 having the malicious logic. The application validator 204 can include a message or instruction in the validation report 236 indicating that the application 206 includes malicious logic and is blocked.

In some embodiments, the validation report 236 can identify if the application 206 is a newer or updated version of the application 206. For example, the validation can identify the differences in the properties 220 of the application 206 and the properties 220 of the other instances 228 of the application 206 corresponds to an updated or newer version of the application 206. The updated version can include one or more different properties 220 from the properties 220 of the other instances 228 of the application 206. The application validator 204 can update the application signature 214 of the application 206 with the one or more different properties 220 and update the at least one known signature 218 corresponding to the other instances 228 of the application 206 with the one or more different properties 220.

In some embodiments, the validation report 236 can identify if the application 206 includes a bug or is executing incorrectly. For example, the application validator 204 can determine that the application 206 is using an incorrect amount of memory, incorrect APIs, incorrect amount of bandwidth, or incorrect amount of processing power. The bug can cause decreased performance by the application 206 on a device 210. In some embodiments, the bug can cause system degradation of a device 210 executing the application 206, such as but not limited to, causing the device 210 to crash. Thus, the application validator 204 can use the validation to track and identify issues with the applications during publish time and/or run time.

In some embodiments, the validation report 236 can identify if the application 206 is accessing inappropriate or malicious endpoints within the network 203 or other network. For example, the differences between the properties 220 of the application 206 and the properties 220 of the other instances 228 of the application 206 can indicate malicious actions by the application 206 that may harm a device 210 executing the application 206. The application validator 204 can determine that the application 206 attempted to access a restricted IP address, a restricted domain name or a restricted API 234. For example, the application validator 204 can identify that an API 234 of a plurality of APIs 234a-234n called by the application 206 is different from the APIs 234a-234n included in the properties 220 of the other instances 228 of the application 206. The called API 234 can include a restricted API 234. The application validator 204 can prevent or block the application 206 from accessing, executing or interacting with the restricted API 234. Thus, the validation report 236 can indicate that one or more APIs 234a-234n are restricted, one or more IP addresses are restricted, one or more domain names are restricted, and/or one or more network endpoints are restricted. The application validator 204 can provide the validation report 236 to an administrator of a network the device 210 is coupled with or to a user of the device 210. For example, the application validator 204 can display the validation report 236 on the device 210 when the device 210 downloads, activates or is executing the respective application 206. In some embodiments, the validation report 236 can be included within a permission profile 222 for the application 206.

Referring now to operation (330), and in some embodiments, security capabilities 226 of the application 206 can be determined. In some embodiments, the application validator 204 can use the identification results and validation report 236 to determine the security capabilities 226 of the application 206. The security capabilities 226 can correspond to the properties 220 of the application 206 and the properties 220 of the category of applications 206. In some embodiments, the security capabilities 226 can include memory usage, API usage, bandwidth usage, processor usage, and/or network usage. For example, the application validator 204 can generate a security capability 226 for the application 206 corresponding to an allowed memory usage range for the application 206. Thus, memory usage outside the generated range can indicate inappropriate use, issues with the application 206 or malicious logic.

The application validator 204 can generate a security capability 226 for the application corresponding to an allowed APIs 234a-234n for the application 206. If the application 206 calls, accesses or interacts with an API 234 not included in the allowed API 234a-234n list such actions can indicate inappropriate use, issues with the application 206 or malicious logic. In some embodiments, the application validator 204 can compile a listing of security permissions requested by a plurality of APIs 234a-234n during execution of the application 206. The security permissions can include requests from an API 234 for access to a system or component of a device 210, data or information from a user of the device 210, and/or data or information from a user of the device 210. In some embodiments, the application validator 204 can retrieve the security permission requests from APIs 234a-234n through binary analysis of the application 206, the API 234 or interactions between the application 206 and the API 234. The application validator 204 can generate the security capability 226 for the application 206 corresponding to an allowed bandwidth usage range or network traffic range for the application 206. Bandwidth usage or network traffic usage outside theses ranges can indicate inappropriate use, issues with the application 206 or malicious logic. The application validator 204 can generate the security capability 226 for the application 206 corresponding to an allowed processor usage range for the application 206. Processor usage outside this range can indicate inappropriate use, issues with the application 206 or malicious logic.

Referring now to operation (335), and in some embodiments, a security profile 230 can be generated for the application 206. The security profile 230 can include one or more security permission requests from an API 234. In some embodiments, the application validator 204 can compile the listing of security permissions requested by the plurality of APIs 234a-234n during execution of the application 206 and generate a security profile 230 indicating responses to the security permissions requested by the plurality of APIs 234a-234n during execution of the application 206. For example, but not limited to, the security profile 230 can include security permission requests corresponding to requests to access a camera or image device of the device 210, requests to access a GPS system of the device 210, requests to access an address system of the device 210, and/or requests to access a telephone system of the device 210. The security profile 230 can include responses from the device 210 to the security permission requests from the APIs 234a-234n. For example, the security profile 230 can include response data indicating if the device 210 accepted the security permission request (e.g., processed or allowed the security permission request) or if the device 210 rejected or blocked the security permission request. The response data can indicate if the security capability, system or component of the device 210 was accessed by or used by an API 234.

In some embodiments, a usage profile 232 can be generated for the application 206. The application validator 204 can generate the usage profile 232 having data corresponding to APIs 234a-234n used by the application 206. For example, in some embodiments, the application validator 204 can determine which APIs 234a-234n the application called, accessed or interacted with during execution of the application 206 and how often the application 206 called, accessed or interacted with the APIs 234a-234n. The usage profile 232 can include API data for APIs 234a-234n indicated as permissible or allowed by the application validator 204. The application validator 204 can generate a usage profile 232 for the plurality of APIs 234a-234n corresponding to the application 206.

Referring now to operation (340), and in some embodiments, a permission profile 222 can be generated for the application 206. For example, the method 300 can include generating, by the application validator 204 and responsive to the validation, a permission profile 222 for the application 206. The permission profile 222 can include a listing of security capabilities 226 of the application 206 for executing on the device 210. The permission profile can include policies from the application server 202, an administrator of the application server 202, the application validator 204, or an administrator corresponding to the application 206. The permission profile 222 can include the validation report 236, the usage profile 232, and the security profile 230. The policies from the administrator of the application server 202 can correspond to network policies or VPN policies for executing the application 206 on devices 210 coupled with the respective network 203. For example, the policies from the administrator can include which applications 206 are permissible and which applications 206 are denied access to the network 203. The policies from the administrator can include what functionality of the application 206 is allowed within the network 203 or when the application 206 is executing on a device (e.g., device 210) coupled with the network 203.

In some embodiments, the permission profile 222 can include data that an operating system of the device 210 may not track or include. For example, the application validator 204 can generate the permission profile 222 having a number of file accesses by the application 206, a number of data bytes transmitted by the application 206, or a number of data bytes received by the application 206. The application validator 204 can generate the permission profile 222 to include time data corresponding to a time value of when the application 206 transmitted a security permission request, when the application 206 called an API 234, when an API 234 accessed or attempted to access the application 206 or systems of the device 210. Thus, the application validator 204 can generate the permission profile 222 to include a plurality of different information corresponding to the interaction of an application 206 when executing on a device 210.

Referring now to operation (345), and in some embodiments, the application data 208 can be provided. For example, method 300 can include providing, by the server 202, the application data 208 from the plurality of data sources to the application 206 executable on the mobile device 210 in response to the difference in security capabilities 226 of the first and second instances of the application 226 being at or above a threshold level. The threshold level can correspond to a signature threshold level indicating a difference between an application signature 214 of an application 206 (e.g., first instance) and a known signature 218 of a second instance 228 of the application 206. The application server 202 or application validator 204 can provide the application data 208 to the application 206 for display on a device 210 when the difference in security capabilities 226 is at or above (e.g., greater than) the signature threshold. The application 206 can display the application data 208 on the device 210 in response to receiving the application data 208. For example, the application data 208 can be provided in the permission profile 22 for the application. The permission profile 222 can include the application data 208 collected for the application 206. The permission profile 222 can include the security profile 230 and the usage profile 232 generated for the application 206. In some embodiments, the application validator 204 can provide the permission profile 222 to the application server 202, an administrator of the application server 202, the device 210 or a user of the device 210. In some embodiments, the application validator 204 can provide the permission profile 222 to the device 210 for display on the device 210. The application validator 204 can display the permission profile 222 on the device 210 when the device 210 downloads, activates or is executing the respective application 206. For example, the application validator 204 can provide a user of the device 210 a listing of the security capabilities 226 that the application 206 has previously accessed, attempted to access or is currently using (e.g., during run time). The permission profile 222 can indicate to a user of the device 210 if the device 210 allowed a security permission request from the application 206 or denied a security permission request from the application 206. In some embodiments, the permission profile 222 can indicate to a user of the device 210 if the device 210 allowed or denied security permission requests in real time. Thus, the permission profile 222 can notify a user of the device 210 the APIs 234a-234n, features or systems the application 206 is accessing or otherwise interacting with while executing on the device 210. In some embodiments, the permission profile 222 can provide the security capability data for the application 206 in real time. In some embodiments, the application validator 204 can update the permission profile 222 for an application 206 during execution of the application 206. For example, the application validator 204 can receive application data 208 (e.g., dynamic application data) indicating new or different security capabilities accessed or attempted to access by the application 206 executing on the device 210.

The application validator 204 can provide the permission profile 222 to the application server 202. For example, the application validator 204 can provide the permission profile to the application server 202 for an administrator of the network 203 or to a network device managing traffic and/or devices coupled with the network 203. The permission profile 222 can include the application data 208 collected for the application 206. The permission profile 222 can include the security profile 230 and the usage profile 232 generated for the application 206. For example, the application validator 204 transmit the permission profile 222 to the administrator of the network 203 or network device managing the network 203 (e.g., application server 202). In some embodiments, the application validator 204 can store the permission profile 222 in a database 216 or external server that is accessible by the administrator of the network 203 or network device managing the network 203. The permission profile 222 for the administrator of the network 203 or network device managing the network 203 can include averaged data corresponding to multiple applications 206 or multiple devices 210 accessing a common application 206. For example, the application validator 204 can generate a permission profile 222 for a category of applications 206 or a group of instances 228 of an application 206. The permission profile 222 for the category of applications 206 or the group of instances 228 of an application 206 can include averaged properties 220 corresponding to an average value for the properties 220 of each of the applications 206 included within the category of applications 206 or the group of instances 228 of an application 206.

In some embodiments, the application validator 204 can generate the permission profile 222 to include and provide data corresponding to a number of times an application 206 generates the same security permission request. For example, the application 206 may transmit a security permission request multiples times per day or multiple times over a time period (e.g., week, month) for permission to access or use different functionalities or systems of the device 210 (e.g., camera functionality, GPS systems, printer functionality). The permission profile 222 can include data indicating if each security permission request, if the security requests were allowed at certain times, or if the security permission requests were prevented or denied.

In some embodiments, the permission profile 222 can identify patterns in the applications 206 behavior or interactions with the device 210. For example, the application 206 may repeatedly request access to a function or system (e.g., address book) of the device 210. The application validator 204 can determine that the application 206 is accessing the function or system of the device 210. The application validator 204 can determine that the application 206 is attempting to access a function or system of the device 210 and has been repeatedly denied. The application validator 204 can generate the permission profile 222 to include the behavior patterns of the application 206 and provide the permission profile 222 to the administrator of the network 203 or network device managing the network 203. In some embodiments, the application validator 204 or administrator can verify if this behavior is permissible or not. For example, the application validator 204 or administrator can compare the behavior pattern to the security policies for the application 206, the network 203 or the device 210. The application validator 204 or administrator can determine the behavior is not permitted. Responsive to the determination, the application validator 204 or administrator can change a policy for the application 206 to prevent or lock the application 206 from accessing the function or system of the device 210.

The permission profile 222 can include the listing of the security capabilities 226 of the application 206 that an administrator, the application server 202, or application validator 204 has blocked or denied. In some embodiments, an administrator, the application server 202, or application validator 204 may block an application 206 from accessing a camera or image device of a device 210. The permission profile 222 can include an entry indicating the camera functionality is blocked for the application 206 and present this information to a user of the device 210. Thus, a user of device 210 can use this information to understand why certain features of an application 206 are unavailable, have been blocked or will be blocked.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

1. A method comprising:
(a) receiving, by a server, application data from a plurality of data sources, the application data corresponding to a first instance of an application executable on a mobile device;
(b) identifying, by the server, security capabilities of the first instance and a second instance of the application based on properties of the first and second instances of the application and a plurality of application program interfaces (APIs) corresponding to the first and second instances of the application;
(c) determining, by the server and responsive to the identification, a difference in security capabilities of the first and second instances of the application, the difference in security capabilities indicating a security vulnerability of the first instance of the application; and
(d) providing, by the server, the application data from the plurality of data sources to the application executable on the mobile device in response to the difference in security capabilities of the first and second instances of the application being at or above a threshold level.

2. The method of claim 1, wherein (a) further comprises identifying, by the server, static application data corresponding to the first instance of the application from a mobile application package or an administrator file.

3. The method of claim 1, wherein (a) further comprises:
injecting, by the server, a monitoring module into the application; and
transmitting, by the monitoring module to the server, dynamic application data corresponding to the application during execution of the application.

4. The method of claim 1, further comprising generating, by the server, a first application signature for the first instance of the application using the application data from the plurality of data sources, the application signature including properties of the first instance of the application and the plurality of APIs corresponding to the first instance of the application.

5. The method of claim 4, further comprising comparing, by the server, the first application signature for the first instance of the application to a second application signature of the application during at least one of: at publishing time of the application or during execution of the application.

6. The method of claim 1, further comprising validating, by the server, the first instance of the application by comparing the properties of the first and second instances of the application.

7. The method of claim 1, wherein (b) further comprises:
assigning weight values to each of the properties of the first instance of the application, and
identifying the second instance of the application using a signature threshold and the assigned weight values for each of the properties of the first instance of the application.

8. The method of claim 1, wherein (c) further comprises:
determining, by the server, one or more differences between the properties of the first instance of the application and the properties of the second instance of the application; and
generating, by the server, a validation report indicating the one or more differences between the properties of the first instance of the application and the properties of the second instance of the application.

9. The method of claim 1, wherein (c) further comprises:
identifying, by the server, malicious logic included within the first instance of the application; and
preventing, by the server, the mobile device from accessing the first instance of the application.

10. The method of claim 1, wherein (c) further comprises:
identifying, by the server, an updated version of the first instance of the application, the updated version having one or more different properties;
updating, by the server, an application signature for the first instance of the application with the one or more different properties; and
updating, by the server, a second application signature for the second instance of the application with the one or more different properties.

11. The method of claim 1, wherein (c) further comprises:
identifying, by the server, an API of the plurality of APIs called by the application, the API different from APIs included in the properties of the first and second instances of the application; and
preventing, by the server, the application from executing the API.

12. The method of claim 1, wherein (d) further comprises generating, by the server, a usage profile for the plurality of APIs corresponding to the application.

13. The method of claim 1, wherein (d) further comprises:
compiling, by the server, a listing of security permissions requested by the plurality of APIs during execution of the application; and
generating, by the server, a security profile indicating responses to the security permissions requested by the plurality of APIs during execution of the application.

14. A system for application security, the system comprising:
a server, wherein the server is configured to:
receive application data from a plurality of data sources, the application data corresponding to a first instance of an application executable on a mobile device;
identify security capabilities of the first instance and a second instance of the application based on properties of the first and second instances of the application and a plurality of application program interfaces (APIs) corresponding to the first and second instances of the application;
determine, responsive to the identification, a difference in security capabilities of the first and second instances of the application, the difference in security capabilities indicating a security vulnerability of the first instance of the application; and
provide application data from the plurality of data sources to the application executable on the mobile device in response to the difference in security capabilities of the first and second instances of the application being at or above a threshold level.

15. The system of claim 14, wherein the server is further configured to inject a monitoring module into the application; and
wherein the monitoring module is further configured to transmit, to the server, dynamic application data corresponding to the application during execution of the application.

16. The system of claim 14, wherein the server is further configured to:
validate the first instance of the application by comparing the properties of the first and second instances of the application.

17. The system of claim 14, wherein the server is further configured to:
generate a first application signature for the first instance of the application using the application data from the plurality of data sources, the application signature including properties of the first instance of the application and the plurality of APIs corresponding to the first instance of the application; and
compare the first application signature to a second application signature for the second instance of the application to determine the difference in security capabilities of the first and second instances of the application.

18. The system of claim 14, wherein the server is further configured to:
identify malicious logic included within the first instance of the application; and
prevent the device from accessing the first instance of the application.

19. A non-transitory computer-readable medium, comprising instructions that, when executed by the processor of a device, cause the processor to:
receive application data from a plurality of data sources, the application data corresponding to a first instance of an application executable on a mobile device;
identify security capabilities of the first instance and a second instance of the application based on properties of the first and second instances of the application and a plurality of application program interfaces (APIs) corresponding to the first and second instances of the application;
determine, responsive to the identification, a difference in security capabilities of the first and second instances of the application, the difference in security capabilities indicating a security vulnerability of the first instance of the application; and
provide application data from the plurality of data sources to the application executable on the mobile device in response to the difference in security capabilities of the first and second instances of the application being at or above a threshold level.

20. The computer-readable medium of claim 19, further comprising instructions that cause the processor to:
identify, responsive to the identification, an updated version of the first instance of the application, the updated version having one or more different properties; and
update the application signature of the first instance of the application with the one or more different properties; and
update the at least one known signature corresponding to the second instance of the application with the one or more different properties.
